(19) United States
(12) Patent Application Publication
(10) Pub. No.: US 2020/0079314 A1
(43) Pub. Date: Mar. 12, 2020

(54) ROOF RAIL AIRBAG WITH ANTI-TWIST SPLINE

(71) Applicant: GM Global Technology Operations LLC, Detroit, MI (US)

(72) Inventors: Kenneth M. Zawisa, Brighton, MI (US); Patrick Landis, Washington, MI (US)

(21) Appl. No.: 16/123,322

(22) Filed: Sep. 6, 2018

(51) Int. Cl. B60R 21/232; B60R 21/213; B60R 21/237

(52) U.S. Cl. CPC B60R 21/232; B60R 2021/23192; B60R 21/237; B60R 21/213

(57) ABSTRACT

A vehicle airbag system includes an airbag having a stiffened portion and an inflatable portion connected to the stiffened portion. A pocket is formed in the stiffened portion between first and second sewn seams. The pocket has a closed end wall defining a first end of the pocket and a pocket entrance defining a second end of the pocket. An elongated spline is disposed in the pocket through the pocket entrance, the spline when fully received in the pocket resisting torsional motion of the vehicle airbag system in an inflatable portion non-deployed condition.

### INTRODUCTION

The present disclosure relates to airbags and airbag mounting for automobile vehicles.

Airbags for automobile vehicles including cars, trucks, sport-utility vehicles and the like are commonly provided in multiple locations about a passenger compartment of the vehicle, including mounted to different roof rails of the vehicle. To both mount and allow for deployment of the airbags, a stripe of different color, a strap, a shape-maintainer, or a similar item is added to the airbag or is connected to structure of the vehicle which provides an anti-twist function, preventing airbag twisting which inhibits deployment. Airbag anti-twist features are also commonly provided to prevent the airbag from becoming mis-aligned during airbag installation. However, the anti-twist features may not be available to suit all mounting locations of the airbag to the vehicle structure, for example where it is necessary to avoid packaging features such as electronics, power supplies, and the like.

Known anti-twist and shape maintainer features include an elongated polymeric material tube including mounting flanges with apertures for installation fasteners. The tooling costs, vehicle part costs, and installation interference issues associated with known shape maintainers are prohibitive.

Thus, while current vehicle airbag twist maintainers achieve their intended purpose, there is a need for a new and improved vehicle airbag system that resists twisting motion of the airbag during assembly and during and after installation into a vehicle.

### SUMMARY

According to several aspects, a vehicle airbag system includes an airbag having a stiffened portion and an inflatable portion connected to the stiffened portion. A pocket is formed in the stiffened portion. An elongated spline is disposed in the pocket resisting torsional motion of the vehicle airbag system in an inflatable portion non-deployed condition.

According to several aspects, the pocket includes a pocket entrance permitting sliding entrance of the spline into the pocket.

According to several aspects, the pocket entrance includes a restriction element allowing the spline to enter the pocket in a first direction but inhibiting the spline from moving out of the pocket in an opposite second direction.

According to several aspects, the restriction element includes an opening smaller than a width of the pocket; and the restriction element includes airbag material arranged in a tapering or an hourglass formation.

According to several aspects, the spline includes an arrow-head shaped end having a recess in the arrow-head shaped end; and the restriction element includes airbag material defining a tab creating an inwardly extending portion of the material of the pocket which enters the recess and frictionally engages and thereby retains the spline in the pocket.

According to several aspects, the stiffened portion includes a first sewn seam and a second sewn seam defining the pocket between the first sewn seam and the second sewn seam.

According to several aspects, the first sewn seam and the second sewn seam are substantially parallel to each other.

According to several aspects, the spline is molded from a polymeric material permitting limited elastic longitudinal bending between a first face and an oppositely facing second face during spline installation but inhibiting side-to-side torsional deflection.

According to several aspects, the pocket includes a closed end wall positioned at an opposite end of the pocket with respect to the pocket entrance; and a length of the pocket is greater than a length of the spline such that the spline is totally enclosed within the pocket.

According to several aspects, a width of the spline is greater than a thickness of the spline. A first face of the spline is substantially parallel to an oppositely facing second face of the spline; and opposed edges of the spline are rounded.

In another aspect of the present disclosure, a vehicle airbag system includes an airbag having a stiffened portion and an inflatable portion connected to the stiffened portion. A pocket is formed in the stiffened portion between first and second sewn seams. The pocket has a closed end wall defining a first end of the pocket and a pocket entrance defining a second end of the pocket. An elongated spline is disposed in the pocket through the pocket entrance, the spline when fully received in the pocket resisting torsional motion of the vehicle airbag system in an inflatable portion non-deployed condition.

According to several aspects, a body of the spline is substantially rectangular-shaped, having a thickness which is less than a width to permit limited elastic bending of the spline.

According to several aspects: the pocket entrance includes a restriction element allowing the spline to enter the pocket in a first direction but inhibiting the spline from moving out of the pocket in an opposite second direction; and the restriction element defines an airbag material flap displaced after entrance of the spline into the pocket to thereafter preclude removal of the spline from the pocket.

According to several aspects, the stiffened portion includes at least one projecting edge integrally and homogeneously connected to a support web.

According to several aspects, the at least one projecting edge includes a first projecting edge and a second projecting edge, each having an aperture for through-installation of a threaded fastener to mount the airbag to a vehicle structural member.

According to several aspects, the stiffened portion is located at a predetermined distance from an upper outer edge of the support web, the distance providing space for a full width of the second sewn seam.

According to several aspects, a first end and an opposed second end of the spline are rounded to allow sliding installation of the spline into the pocket with either the first end or the second end being inserted first into the pocket.

According to several aspects, a vehicle airbag system includes an airbag having a stiffened portion and an inflatable portion connected to the stiffened portion, the stiffened portion including at least one projecting edge. A pocket is formed in the stiffened portion between first and second sewn seams, the pocket having a closed end wall defining a first end of the pocket. A pocket entrance defines a second end of the pocket. A restriction element of the pocket allows the spline to enter the pocket in a first direction but inhibits the spline from moving out of the pocket in an opposite second direction. An elongated spline is disposed in the pocket through the pocket entrance. The spline when fully received in the pocket resists torsional motion of the vehicle airbag system in an inflatable portion non-deployed condition. The spline includes: a width substantially equal to a width of the pocket to frictionally engage and frictionally retain the spline within the pocket; a length less than a length of the pocket such that the spline is totally enclosed within the pocket.

According to several aspects, a vehicle has a structural member, with the airbag being mounted to the structural member.

According to several aspects, the structural member defines a roof pillar, and the airbag is mounted to the structural member with a fastener extending through an aperture of the projecting edge.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a side elevational view of a vehicle airbag system according to an exemplary embodiment;

FIG. 2 is a side elevational view of area 2 of FIG. 1;

FIG. 3 is a side elevational view of a deployed airbag of the vehicle airbag system of FIG. 1;

FIG. 4 is a side elevational view of another aspect similar to area 2 of FIG. 1;

FIG. 5 is a top perspective view of a spline for the vehicle airbag system of FIG. 1; and

FIG. 6 is a side elevational view of another aspect similar to area 2 of FIG. 1.

### DETAILED DESCRIPTION

The following description is merely exemplary in nature and is not intended to limit the present disclosure, application, or uses.

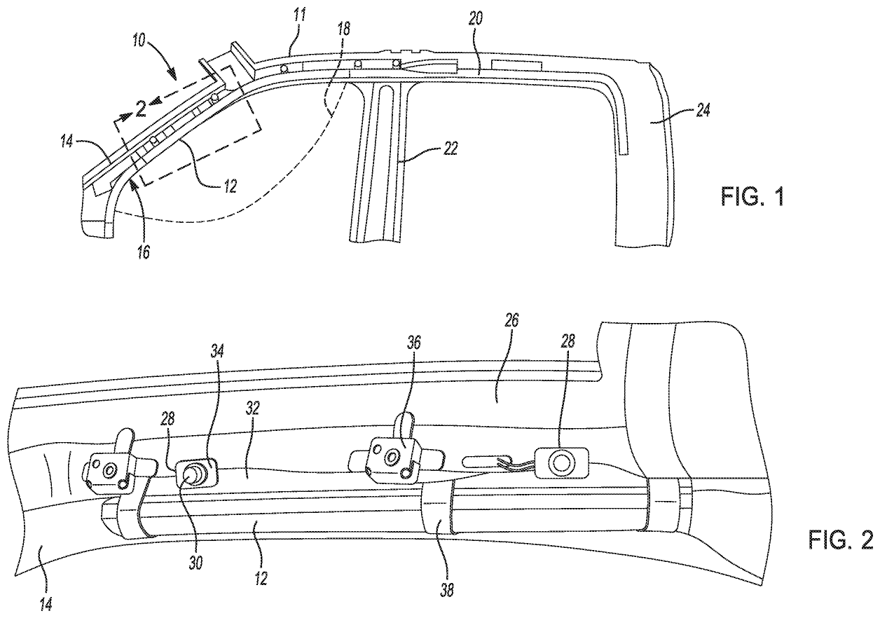

Referring to FIG. 1, a vehicle airbag system 10 for installation into a vehicle 11 includes an airbag assembly 12 which in a non-deployed condition is mounted to structure of the vehicle 11, such as to a vehicle A-pillar 14, thereby defining a side-curtain airbag. The airbag assembly 12 in the non-deployed condition is located proximate to an inner edge 16 of the vehicle A-pillar 14 to maximize the extension of the airbag assembly 12 in an inflated position 18 into an occupant space of the vehicle 11. Additional airbag assemblies similar to the airbag assembly 12, such as a second airbag assembly 20 modified for example to account for different dimensions including length and different mounting conditions can be mounted to vehicle structure such as between a vehicle B-pillar and a vehicle C-pillar, or to similar structure.

Referring to FIG. 2 and again to FIG. 1, the airbag assembly 12 is fixedly mounted to a structural member 26 such as a roof structure using fastener assemblies 28. Each of the fastener assemblies 28 includes a threaded fastener 30 extending through a support web 32 of the airbag assembly 12 to be threadably engaged with the structural member 26. Each of the fastener assemblies 28 further includes a mounting bracket 34 which spreads out the loading force of the threaded fastener 30 to a larger area of the support web 32 than provided by a loading area of the threaded fastener 30. The location of the airbag assembly 12 and the positions of the fastener assemblies 28 are selected to provide clearance to other items also mounted to or supported by the structural member 26, such as one or more trim mounting brackets 36. One or more straps 38 are also attached to the airbag assembly 12 to retain an installed shape and longitudinal position of the airbag assembly 12 prior to subsequent installation of vehicle trim members (not shown) which cover the airbag assembly 12 and the structural member 26 while permitting deployment of the airbag assembly 12. The straps 38 release during deployment of the airbag assembly 12.

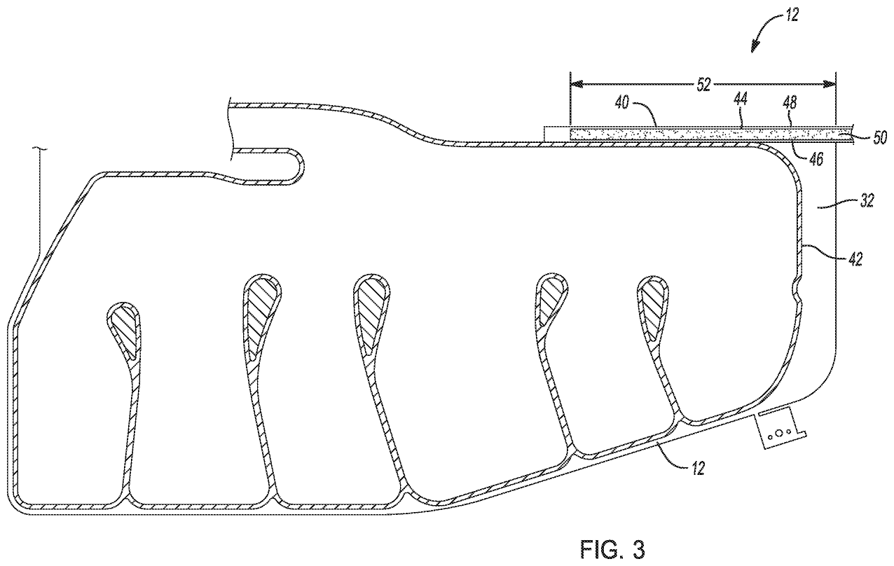

Referring to FIG. 3 and again to FIGS. 1 and 2, the airbag assembly 12 has a stiffened portion 40 of the support web 32 separated from an inflatable portion 42 shown in an airbag inflated or deployed position. The stiffened portion 40 includes an elongated pocket 44 which is created between a first longitudinal sewn seam 46 and a substantially parallel second longitudinal sewn seam 48. The first sewn seam 46 and the second sewn seam 48 separate the stiffened portion 40 of the support web 32 from the inflatable portion 42. A spline 50 is slidably disposed in the pocket 44 which inhibits torsional twisting of the airbag assembly 12 during assembly and installation into the vehicle 11. A geometry of the spline 50 is therefore predetermined based on a material of the spline 50 and the dimensions of the spline 50 which are described in greater detail in reference to FIG. 5.

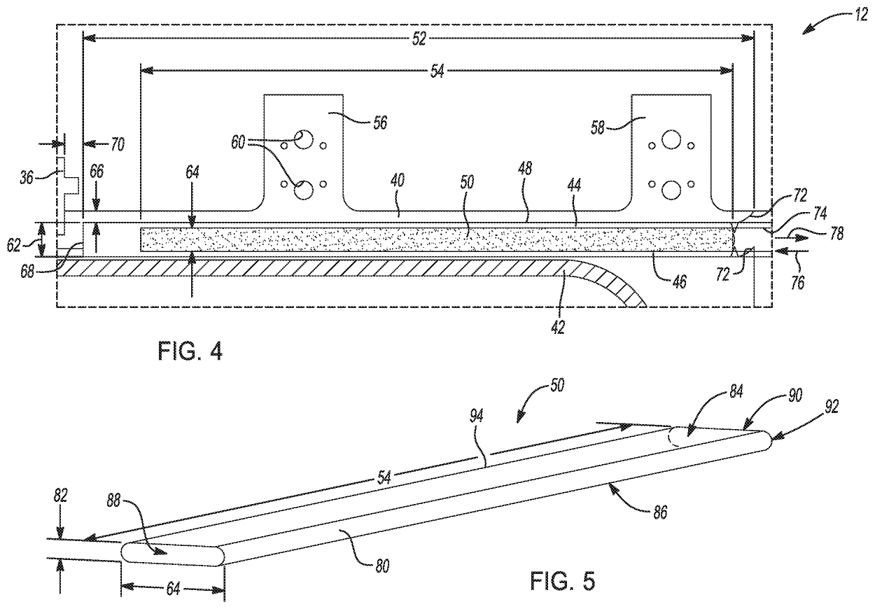

Referring to FIG. 4 and again to FIGS. 2 and 3, the stiffened portion 40 is shown in greater detail, and shows the spline 50 in its installed position in the pocket 44, frictionally retained between the first sewn seam 46 and the second sewn seam 48. A length 52 of the pocket 44 is greater than a length 54 of the spline 50 such that the spline 50 is totally enclosed within the pocket 44. A first projecting edge 56 and a second projecting edge 58 integrally and homogeneously connected to the support web 32 extend outwardly from the stiffened portion 40 to act as support features for attaching the airbag assembly 12 using the fastener assemblies 28. Each of the first projecting edge 56 and the second projecting edge 58 include apertures 60 for through-installation of the threaded fasteners 30. A width 62 of the pocket 44 and a width 64 of the spline 50 are therefore predetermined to frictionally engage and retain the spline 50 within the pocket 44. To maximize the anti-rotational benefit of the spline 50, the stiffened portion 40 is located at a distance 66 from an upper outer edge of the support web 32, the distance 66 being predetermined to be as close as practical to the outer edge of the airbag assembly 12 as shown in FIG. 4, while providing space for a full width of the second sewn seam 48.

A closed end wall 68 defining a first end of the pocket 44 is provided for the pocket 44 which is located at a distance 70 spaced away from anticipated locations of objects such as one of the trim mounting brackets 36. The distance 70 is predetermined, such that if the spline 50 contacts the closed end wall 68, the spline 50 is prevented from interfering with objects such as one of the trim mounting brackets 36, which could detrimentally interfere with full insertion of the spline 50 or cause torsional rotation of the spline 50. Positioned opposite to the closed end wall 68 is a pocket entrance 72 defining a second end of the pocket 44. According to several aspects the pocket entrance 72 includes a restriction element 74. The restriction element 74 can be provided in one of multiple forms. The restriction element 74 can therefore define one of an opening smaller than the width 62 of the pocket 44, a tortuous path having for example airbag material arranged in a tapering or an hourglass formation acting to resist sliding movement of the spline 50 past the tortuous path, an airbag material flap displaced after entrance of the spline 50 to thereafter preclude removal of the spline 50 from the pocket 44, or a similar feature. The restriction element 74 allows the spline 50 to be inserted into the pocket 44 in an installation direction 76 but resists or prevents movement of the spline 50 in a release direction 78 opposite to the installation direction 76. The spline 50 is therefore intended to be retained within the pocket 44 after installation through or past the restriction element 74.

Referring to FIG. 5 and again to FIG. 4, according to several aspects, the spline 50 is molded from a polymeric material which permits limited elastic longitudinal bending during spline installation but inhibits torsional deflection. The polymeric material can be for example a glass-filled polypropylene or a composite material. According to further aspects, the spline 50 can be a metal material including aluminum. To permit limited elastic bending, a body 80 of the spline 50 is substantially rectangular-shaped, having a thickness 82 which is less than the width 64. A first planar surface 84 and an oppositely facing second planar surface 86 of the body 80 are substantially parallel to each other allowing equal elastic longitudinal bending of the spline 50 along the length of the spline. A first end 88 and an opposed second end 90 may be rounded to allow sliding installation of the spline 50 into the pocket 44 with either the first end 88 or the second end 90 being inserted first into the pocket 44. A first outer edge 92 and an oppositely facing second outer edge 94 are also rounded to assist in sliding installation of the spline 50. The rectangular shape of the spline described above is not limiting, as the spline 50 can have other geometric shapes that may be necessitated by the installation space of the vehicle.

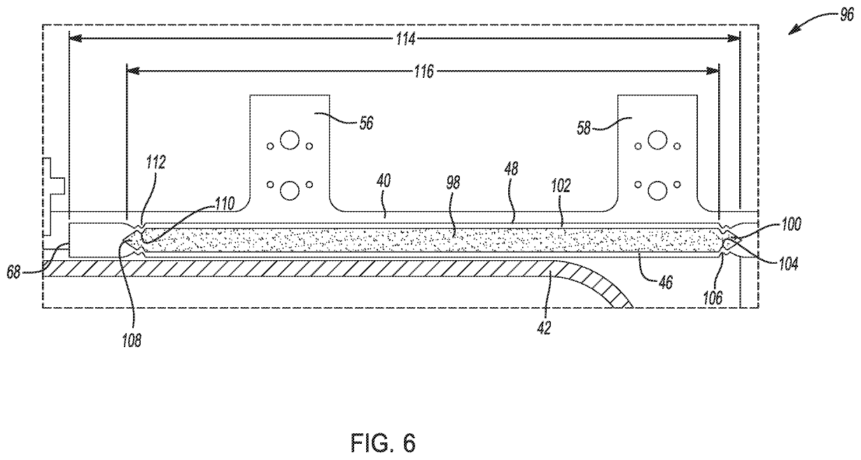

Referring to FIG. 6 and again to FIGS. 2, 3 and 4, according to several aspects, an airbag assembly 96 is modified from the airbag assembly 12, therefore only the differences will be further discussed herein. The airbag assembly 96 includes a spline 98 modified from the spline 50 to include a first arrow-head shaped end 100 at a first end of the spline 98. The stiffened portion is shown in greater detail and shows the spline 98 in its installed position in a pocket 102, modified from the pocket 44, frictionally retained between the first sewn seam 46 and the second sewn seam 48. To further retain the first arrow-head shaped end 100 a recess 104 in the first arrow-head shaped end 100 is provided. The recess 104 frictionally engages a tab 106 defining an inwardly extending portion of the material of the pocket 102 which frictionally engages and thereby retains the spline 98 in the pocket 102.

In lieu of or in addition to the first arrow-head shaped end 100, the spline 98 can include a second arrow-head shaped end 108 at an opposite end of the spline 98. To retain the second arrow-head shaped end 108 a recess 110 created proximate the second arrow-head shaped end 108 receives a tab 112 defining an inwardly extending portion of the material of the pocket 102 which frictionally retains the spline 98 in the pocket 102. A length 114 of the pocket 102 is greater than a length 116 of the spline 98 such that the spline 98 is totally enclosed within the pocket 102.

A vehicle airbag system 10 of the present disclosure offers several advantages. These include an anti-twist spline fixed in position in an airbag assembly that resists twisting motion of the airbag assembly during assembly and during and after installation into a vehicle. The spline is frictionally received in a pocket formed between two sewn seams of the airbag, with a feature added to the pocket to retain the spline within the pocket.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A vehicle airbag system, comprising:
an airbag having a stiffened portion and an inflatable portion connected to the stiffened portion;
a pocket formed in the stiffened portion; and
an elongated spline disposed in the pocket resisting torsional motion of the vehicle airbag system in an inflatable portion non-deployed condition.

2. The vehicle airbag system of claim 1, wherein the pocket includes a pocket entrance permitting sliding entrance of the spline into the pocket.

3. The vehicle airbag system of claim 2, wherein the pocket entrance includes a restriction element allowing the spline to enter the pocket in a first direction but inhibiting the spline from moving out of the pocket in an opposite second direction.

4. The vehicle airbag system of claim 3, wherein:
the restriction element includes an opening smaller than a width of the pocket; and
the restriction element includes airbag material arranged in a tapering or an hourglass formation.

5. The vehicle airbag system of claim 3, wherein:
the spline includes an arrow-head shaped end having a recess in the arrow-head shaped end; and
the restriction element includes airbag material defining a tab creating an inwardly extending portion of the material of the pocket which enters the recess and frictionally engages and thereby retains the spline in the pocket.

6. The vehicle airbag system of claim 1, wherein the stiffened portion includes a first sewn seam and a second sewn seam defining the pocket between the first sewn seam and the second sewn seam.

7. The vehicle airbag system of claim 6, wherein the first sewn seam and the second sewn seam are substantially parallel to each other.

8. The vehicle airbag system of claim 1, wherein the spline is molded from a polymeric material permitting limited elastic longitudinal bending between a first face and an oppositely facing second face during spline installation but inhibiting side-to-side torsional deflection.

9. The vehicle airbag system of claim 1, wherein:
the pocket includes a closed end wall positioned at an opposite end of the pocket with respect to the pocket entrance; and
a length of the pocket is greater than a length of the spline such that the spline is totally enclosed within the pocket.

10. The vehicle airbag system of claim 1, wherein:
a width of the spline is greater than a thickness of the spline;
a first face of the spline is substantially parallel to an oppositely facing second face of the spline; and
opposed edges of the spline are rounded.

11. A vehicle airbag system, comprising:
an airbag having a stiffened portion and an inflatable portion connected to the stiffened portion;
a pocket formed in the stiffened portion between first and second sewn seams, the pocket having a closed end wall defining a first end of the pocket and a pocket entrance defining a second end of the pocket; and
an elongated spline disposed in the pocket through the pocket entrance, the spline when fully received in the pocket resisting torsional motion of the vehicle airbag system in an inflatable portion non-deployed condition.

12. The vehicle airbag system of claim 11, wherein a body of the spline is substantially rectangular-shaped, having a thickness which is less than a width to permit limited elastic bending of the spline.

13. The vehicle airbag system of claim 11, wherein:
the pocket entrance includes a restriction element allowing the spline to enter the pocket in a first direction but inhibiting the spline from moving out of the pocket in an opposite second direction; and
the restriction element defines an airbag material flap displaced after entrance of the spline into the pocket to thereafter preclude removal of the spline from the pocket.

14. The vehicle airbag system of claim 11, wherein the stiffened portion includes at least one projecting edge integrally and homogeneously connected to a support web.

15. The vehicle airbag system of claim 14, wherein the at least one projecting edge includes a first projecting edge and a second projecting edge, each having an aperture for through-installation of a threaded fastener to mount the airbag to a vehicle structural member.

16. The vehicle airbag system of claim 14, wherein the stiffened portion is located at a predetermined distance from an upper outer edge of the support web, the distance providing space for a full width of the second sewn seam.

17. The vehicle airbag system of claim 11, wherein a first end and an opposed second end of the spline are rounded to allow sliding installation of the spline into the pocket with either the first end or the second end being inserted first into the pocket.

18. A vehicle airbag system, comprising:
an airbag having a stiffened portion and an inflatable portion connected to the stiffened portion, the stiffened portion including at least one projecting edge;
a pocket formed in the stiffened portion between first and second sewn seams, the pocket having a closed end wall defining a first end of the pocket, a pocket entrance defining a second end of the pocket, and a restriction element allowing the spline to enter the pocket in a first direction but inhibiting the spline from moving out of the pocket in an opposite second direction; and
an elongated spline disposed in the pocket through the pocket entrance, the spline when fully received in the pocket resisting torsional motion of the vehicle airbag system in an inflatable portion non-deployed condition, the spline including:
a width substantially equal to a width of the pocket to frictionally engage and frictionally retain the spline within the pocket; and
a length less than a length of the pocket such that the spline is totally enclosed within the pocket.

19. The vehicle airbag system of claim 18, further including a vehicle having a structural member, the airbag being mounted to the structural member.

20. The vehicle airbag system of claim 19, wherein the structural member defines a roof pillar, the airbag being mounted to the structural member with a fastener extending through an aperture of the projecting edge.
